(19) United States
(12) Patent Application Publication
(10) Pub. No.: US 2018/0241802 A1
(43) Pub. Date: Aug. 23, 2018

(54) TECHNOLOGIES FOR NETWORK SWITCH BASED LOAD BALANCING

(71) Applicant: Intel Corporation, Santa Clara, CA (US)

(72) Inventors: Francesc Guim Bernat, Barcelona (ES); Karthik Kumar, Chandler, AZ (US); Thomas Willhalm, Sandhausen (DE); Gaspar Mora Porta, Santa Clara, CA (US); Daniel Rivas Barragan, Cologne (DE)

(21) Appl. No.: 15/437,565

(22) Filed: Feb. 21, 2017

(51) Int. Cl. H04L 29/08; H04L 12/26

(52) U.S. Cl. CPC H04L 67/101; H04L 43/0894; H04L 67/1006; H04L 67/1029; H04L 67/1012

(57) ABSTRACT

Technologies for network switch based load balancing include a network switch. The network switch is to receive messages, route messages to destination computing devices, receive a request to perform a workload, and receive telemetry data from a plurality of server nodes in communication with the network switch. The telemetry data is indicative of a present load on one or more resources of each server node. The network switch is further to determine channel utilization data for each of the server nodes, select, as a function of the telemetry data and the channel utilization data, one or more of the server nodes to execute the workload, and assign the workload to the selected one or more server nodes. Other embodiments are also described and claimed.

### BACKGROUND

With advances in big data computing techniques, there is a growing trend of “scale-out” computing, in which applications utilize one or more servers in a data center to perform a computing task (e.g., compression, decompression, encryption, decryption, authentication, etc.), referred to herein as a “workload.” The workloads may be data parallel, such that when multiple servers are employed, the multiple servers may concurrently operate on subsets of a total data set associated with the workload and thus proceed in parallel. Due to the distributed nature of such workloads, low latency network access to resources located among the servers, such as remote memory access, is an important factor in satisfying quality of service objectives.

In typical systems, a server may perform the role of receiving a request from a client device to process a workload, and based on available resources among the other servers in the system, the server may assign the workload to one or more of the other servers for execution. However, using a server to perform the role of receiving requests from a client device and determining which other servers to assign the workload to typically incur overhead associated with the server pinging the other servers on a periodic basis to determine whether the servers are operative. Furthermore, the server typically does not have a global view of network congestion and traffic within the data center, making it difficult to ensure low-latency access to resources among the servers that are to execute a workload.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for performing network switch based load balancing;

FIG. 2 is a simplified block diagram of at least one embodiment of a network switch of the system of FIG. 1;

FIG. 3 is a simplified block diagram of at least one embodiment of a server node of the system of FIG. 1;

FIG. 4 is a simplified block diagram of an environment that may be established by the network switch of FIGS. 1 and 2;

FIG. 5 is a simplified block diagram of an environment that may be established by a server node of FIGS. 1 and 3;

FIGS. 6 and 7 are a simplified flow diagram of at least one embodiment of a method for managing the distribution of workloads among server nodes, that may be performed by the network switch of FIGS. 1 and 2;

FIGS. 8 and 9 are a simplified flow diagram of at least one embodiment of a method for reporting telemetry data and executing workloads that may be performed by a server node of FIGS. 1 and 3;

FIG. 10 is a simplified diagram of example communications that may be transmitted from a server node to the network switch to provide telemetry data pertaining to one or more resources of the server node;

FIG. 11 is a simplified diagram of example communications that may be transmitted between from multiple server nodes to the network switch to provide updates pertaining to resource utilizations of the server nodes; and

FIG. 12 is a simplified diagram of example communications that may be transmitted between the network switch and the server nodes to balance the assignment of workloads among the server nodes based on the resource utilizations.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

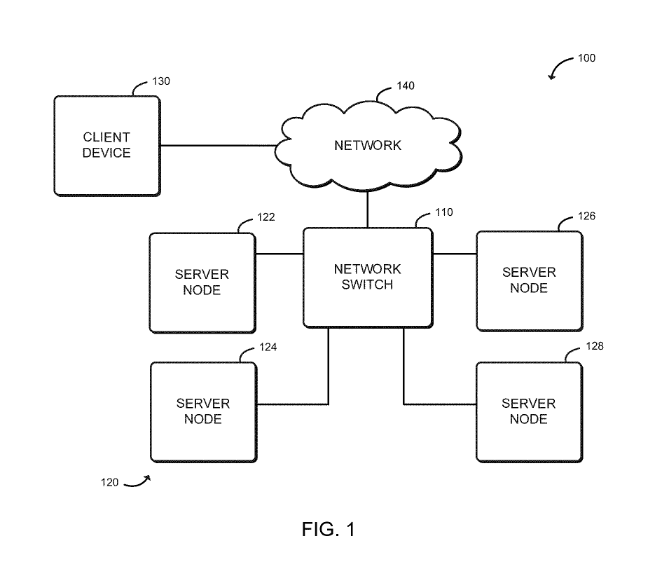

As shown in FIG. 1, an illustrative system 100 for performing network switch based load balancing includes a network switch 110 in communication with a set of server nodes 120. The set of server nodes 120 includes server nodes 122, 124, 126, and 128. While four server nodes 120 are shown in the set, it should be understood that in other embodiments, the set may include a different number of server nodes 120. A client device 130 is in communication with the network switch 110 via a network 140. The system 100 may be located in a data center and provide storage and compute services (e.g., cloud services) on behalf of the client device 130 and/or other client devices (not shown). In operation, the network switch 110 is configured to receive requests from client devices to perform workloads, receive telemetry data from the server nodes 120 indicative of the present utilization of resources of each server node 120 (e.g., CPU load, memory load, database load, etc.), monitor traffic congestion, referred to herein as channel utilization, for each server node 120, and assign workloads to the server nodes 120 as a function of the telemetry data and channel utilization data to satisfy a target quality of service such as a latency, a throughput, and/or a number of operations per second. The network switch 110, in the illustrative embodiment, utilizes dedicated components, such as a field programmable gate array (FPGA), to efficiently perform a load balancing algorithm to select which of the server nodes 120 should execute a given workload. In some embodiments, the network switch 110 may receive requests that indicate one or more types of resources that may be primarily utilized during the performance of the workload (e.g., CPU intensive, memory intensive, etc.), one or more quality of service objectives to be satisfied (e.g., a minimum latency, a minimum number of operations per second, a maximum amount of time to perform the workload, etc.), and/or a designation of one or more of the server nodes 120 to perform the workload. Given that the network switch 110 has information regarding the network congestion associated with each server node 120 and the present resource utilization for each server node 120, the network switch 110 override the designation of one or more server nodes 120 indicated in the request for one or more other server nodes 120 that are presently able to more efficiently perform the workload and satisfy the one or more quality of service objectives.

Each server node 120, in the illustrative embodiment, is configured to monitor resource utilizations in the server node 120, report the resource utilizations to the network switch 110, and execute workloads assigned by the network switch 110. In the illustrative embodiment, the server nodes 120 may execute the workloads in one or more virtual machines or containers. In the illustrative embodiment, the monitoring and reporting functions are performed by a dedicated component in the host fabric interface (HFI) of each server node 120, to increase the efficiency of communicating the telemetry data to the network switch 110. A software stack in each server node 120 may send a message to the HFI indicating that the resource utilization of one or more components (e.g., the CPU, the memory, etc.) has changed, and to send an update message to the network switch 110 of the change. By continually updating the network switch 110 with the telemetry data, the network switch 110 may more accurately determine which server nodes 120 are able to perform a given workload to satisfy the corresponding quality of service (QOS) objectives at any given time.

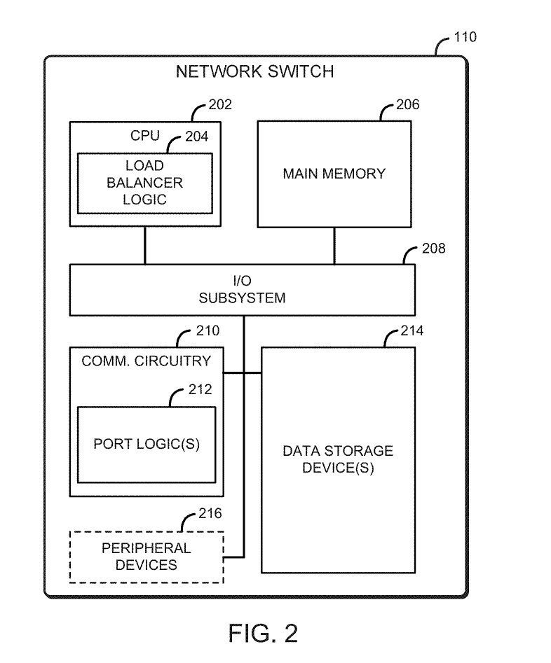

Referring now to FIG. 2, the network switch 110 may be embodied as any type of compute device capable of performing the functions described herein, including receiving requests from client devices (e.g., the client device 130) to perform workloads, receiving telemetry data from the server nodes 120 indicative of the present utilization of resources of each server node 120, determining channel utilizations (e.g., network congestion), and assigning workloads to the server nodes 120 as a function of the telemetry data and channel utilization data to satisfy quality of service objectives. In the illustrative embodiment, the network switch 110 differs from a general purpose computer or server in that the network switch 110 includes multiple port logics 212, as explained below, for receiving messages (e.g., packets) from multiple compute devices (e.g., the server nodes 120) and switching (e.g., routing, redirecting, etc.) the messages among the compute devices. Furthermore, the network switch 110, due to its role in switching the messages with the multiple port logics 212, is able to efficiently determine a global view of the status of the server nodes 120 and the amount of network congestion and traffic within the system 100. As shown in FIG. 2, the illustrative network switch 110 includes a central processing unit (CPU) 202, a main memory 206, an input/output (I/O) subsystem 208, communication circuitry 210, and one or more data storage devices 214. Of course, in other embodiments, the network switch 110 may include other or additional components, such as those commonly found in a computer (e.g., display, peripheral devices, etc.). Additionally, in some embodiments, one or more of the illustrative components may be incorporated in, or otherwise form a portion of, another component. For example, in some embodiments, the main memory 206, or portions thereof, may be incorporated in the CPU 202.

The CPU 202 may be embodied as any type of processor capable of performing the functions described herein. The CPU 202 may be embodied as a single or multi-core processor(s), a microcontroller, or other processor or processing/controlling circuit. In some embodiments, the CPU 202 may be embodied as, include, or be coupled to a field programmable gate array (FPGA), an application specific integrated circuit (ASIC), reconfigurable hardware or hardware circuitry, or other specialized hardware to facilitate performance of the functions described herein. In the illustrative embodiment, the CPU 202 includes load balancer logic 204 which may be embodied as any dedicated circuitry or component capable of performing a load balancing algorithm to select one or more server nodes 120 to execute a given workload to satisfy one or more quality of service objectives, in view of present telemetry data (e.g., present resource utilizations such as the load (e.g., usage of available capacity) on the CPU, memory, accelerators, etc.) and network congestion (i.e., channel utilization) associated with each server node 120. Similarly, the main memory 206 may be embodied as any type of volatile (e.g., dynamic random access memory (DRAM), etc.) or non-volatile memory or data storage capable of performing the functions described herein. In some embodiments, all or a portion of the main memory 206 may be integrated into the CPU 202. In operation, the main memory 206 may store various software and data used during operation such as workload data, telemetry data, channel utilization data, quality of service data, operating systems, applications, programs, libraries, and drivers.

The I/O subsystem 208 may be embodied as circuitry and/or components to facilitate input/output operations with the CPU 202, the main memory 206, and other components of the network switch 110. For example, the I/O subsystem 208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 208 may form a portion of a system-on-a-chip (SoC) and be incorporated, along with one or more of the CPU 202, the main memory 206, and other components of the network switch 110, on a single integrated circuit chip.

The communication circuitry 210 may be embodied as any communication circuit, device, or collection thereof, capable of enabling communications over the network 140 between the network switch 110 and another compute device (e.g., the client device 130 and/or the server nodes 120). The communication circuitry 210 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 210 includes multiple port logics 212. Each port logic 212 may be embodied as one or more add-in-boards, daughtercards, network interface cards, controller chips, chipsets, or other devices that may be used by the network switch 110 to connect with another compute device (e.g., the client device 130 and/or the server nodes 120). In some embodiments, one or more of the port logics 212 may be embodied as part of a system-on-a-chip (SoC) that includes one or more processors, or included on a multichip package that also contains one or more processors. In some embodiments, one or more of the port logics 212 may include a local processor (not shown) and/or a local memory (not shown) that are both local to the port logic 212. In such embodiments, the local processor of the port logic 212 may be capable of performing one or more of the functions of the CPU 202 described herein. Additionally or alternatively, in such embodiments, the local memory of one or more of the port logics 212 may be integrated into one or more components of the network switch 110 at the board level, socket level, chip level, and/or other levels.

The one or more illustrative data storage devices 214, may be embodied as any type of devices configured for short-term or long-term storage of data such as, for example, memory devices and circuits, memory cards, hard disk drives, solid-state drives, or other data storage devices. Each data storage device 214 may include a system partition that stores data and firmware code for the data storage device 214. Each data storage device 214 may also include an operating system partition that stores data files and executables for an operating system.

Additionally, the network switch 110 may include one or more peripheral devices 216. Such peripheral devices 216 may include any type of peripheral device commonly found in a compute device such as a display, speakers, a mouse, a keyboard, and/or other input/output devices, interface devices, and/or other peripheral devices.

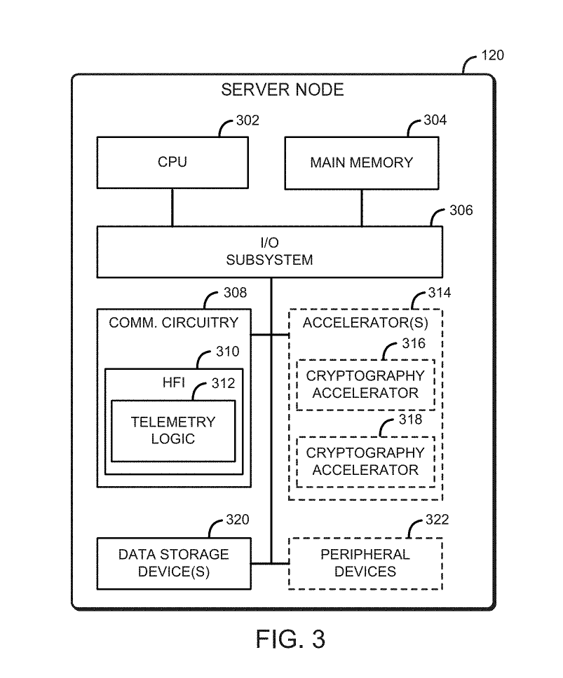

Referring now to FIG. 3, each server node 120 may be embodied as any type of compute device capable of performing the functions described herein, including monitoring resource utilizations within the server node 120, reporting the resource utilizations to the network switch 110, and executing workloads assigned by the network switch 110. As shown in FIG. 3, the illustrative server node 120 includes a central processing unit (CPU) 302, a main memory 304, an input/output (I/O) subsystem 306, communication circuitry 308, and one or more data storage devices 320. Of course, in other embodiments, the network switch 110 may include other or additional components, such as those commonly found in a computer (e.g., display, peripheral devices, etc.). Additionally, in some embodiments, one or more of the illustrative components may be incorporated in, or otherwise form a portion of, another component. For example, in some embodiments, the main memory 304, or portions thereof, may be incorporated in the CPU 302.

The CPU 302 may be embodied as any type of processor capable of performing the functions described herein. The CPU 302 may be embodied as a single or multi-core processor(s), a microcontroller, or other processor or processing/controlling circuit. In some embodiments, the CPU 302 may be embodied as, include, or be coupled to a field programmable gate array (FPGA), an application specific integrated circuit (ASIC), reconfigurable hardware or hardware circuitry, or other specialized hardware to facilitate performance of the functions described herein. Similarly, the main memory 304 may be embodied as any type of volatile (e.g., dynamic random access memory (DRAM), etc.) or non-volatile memory or data storage capable of performing the functions described herein. In some embodiments, all or a portion of the main memory 304 may be integrated into the CPU 302. In operation, the main memory 304 may store various software and data used during operation such as registered resource data indicative of resources of the server node 120 whose utilizations are monitored and reported to the network switch 110, telemetry data, workload data, operating systems, applications, programs, libraries, and drivers.

The I/O subsystem 306 may be embodied as circuitry and/or components to facilitate input/output operations with the CPU 302, the main memory 304, and other components of the server node 120. For example, the I/O subsystem 306 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 306 may form a portion of a system-on-a-chip (SoC) and be incorporated, along with one or more of the CPU 302, the main memory 304, and other components of the server node 120, on a single integrated circuit chip.

The communication circuitry 308 may be embodied as any communication circuit, device, or collection thereof, capable of enabling communications over the network between the server node 120 and another compute device (e.g., the network switch 110 and/or other server nodes 120). The communication circuitry 308 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 308 includes a host fabric interface (HFI) 310. The host fabric interface 310 may be embodied as one or more add-in-boards, daughtercards, network interface cards, controller chips, chipsets, or other devices that may be used by the server node 120 to connect with another compute device (e.g., the network switch 110 and/or other server nodes 120). In some embodiments, the host fabric interface 310 may be embodied as part of a system-on-a-chip (SoC) that includes one or more processors, or included on a multichip package that also contains one or more processors. In some embodiments, the host fabric interface 310 may include a local processor (not shown) and/or a local memory (not shown) that are both local to the host fabric interface 310. In such embodiments, the local processor of the host fabric interface 310 may be capable of performing one or more of the functions of the CPU 302 described herein. Additionally or alternatively, in such embodiments, the local memory of the host fabric interface 310 may be integrated into one or more components of the server node 120 at the board level, socket level, chip level, and/or other levels. In the illustrative embodiment, the host fabric interface 310 includes telemetry logic 312 which may be embodied as any dedicated circuitry or other component capable of monitoring the utilization of one or more physical resources of the server node 120, such as the present load on the CPU 302, the memory 304, or one or more of the accelerators 314 and/or the load on one or more software-based resources of the server node 120, such as a database (e.g., the present number of pending database queries, the average amount of time to respond to a query, etc.), and sending updates to the network switch 110 indicative of the resource utilizations.

The one or more illustrative data storage devices 320, may be embodied as any type of devices configured for short-term or long-term storage of data such as, for example, memory devices and circuits, memory cards, hard disk drives, solid-state drives, or other data storage devices. Each data storage device 320 may include a system partition that stores data and firmware code for the data storage device 320. Each data storage device 320 may also include an operating system partition that stores data files and executables for an operating system.

Additionally, the server node 120 may include one or more accelerators 314 which may be embodied as any type of circuitry or component capable of performing one or more types of functions more efficiently or faster than the CPU 302. In the illustrative embodiment, the accelerators 314 may include a cryptography accelerator 316, which may be embodied as any circuitry or component, such as an application specific integrated circuit (ASIC), a field programmable gate array (FPGA), or other device, capable of performing cryptographic functions, such as encrypting or decrypting data (e.g., advanced encryption standard (AES) or data encryption standard (DES) encryption and/or decryption functions), more efficiently or faster than the CPU 302. Similarly the accelerators 314 may additionally or alternatively include a compression accelerator 318, which may be embodied as any circuitry or component such as an application specific integrated circuit (ASIC), a field programmable gate array (FPGA), or other device, capable of performing data compression or decompression functions, such as Lempel-Ziv compression and/or decompression functions, entropy encoding and/or decoding, and/or other data compression and decompression functions. The accelerators 314 may additionally or alternatively include accelerators for other types of functions.

Additionally, the server node 120 may include one or more peripheral devices 322. Such peripheral devices 322 may include any type of peripheral device commonly found in a compute device such as a display, speakers, a mouse, a keyboard, and/or other input/output devices, interface devices, and/or other peripheral devices.

The client device 130 may have components similar to those described in FIG. 3. The description of those components are equally applicable to the description of components of the client device 130 and is not repeated herein for clarity of the description, with the exception that the client device 130, in the illustrative embodiment, does not include the telemetry logic 312 described above. Further, it should be appreciated that the client device 130 may include other components, sub-components, and devices commonly found in a computing device, which are not discussed above in reference to the server node 120 and not discussed herein for clarity of the description.

As described above, the network switch 110, the server nodes 120, and the client device 130 are illustratively in communication via the network 140, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

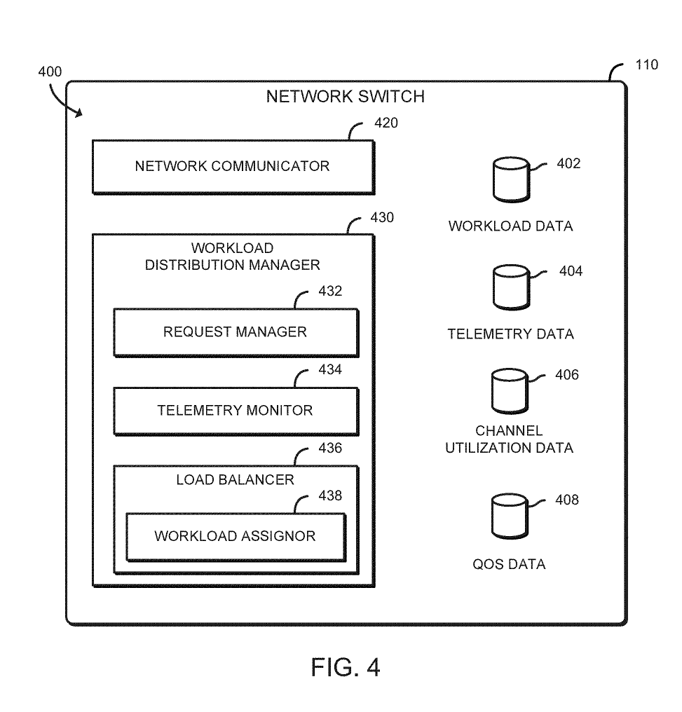

Referring now to FIG. 4, in the illustrative embodiment, the network switch 110 may establish an environment 400 during operation. The illustrative environment 400 includes a network communicator 420 and a workload distribution manager 430. Each of the components of the environment 400 may be embodied as hardware, firmware, software, or a combination thereof. As such, in some embodiments, one or more of the components of the environment 400 may be embodied as circuitry or a collection of electrical devices (e.g., network communicator circuitry 420, workload distribution manager circuitry 430, etc.). It should be appreciated that, in such embodiments, one or more of the network communicator circuitry 420 or workload distribution manager circuitry 430 may form a portion of one or more of the CPU 202, the load balancer logic 204, the main memory 206, the I/O subsystem 208, the communication circuitry 210, and/or other components of the network switch 110. In the illustrative embodiment, the environment 400 includes workload data 402 which may be embodied as identifiers (e.g., process numbers, executable file names, alphanumeric tags, etc.) of each workload assigned and/or to be assigned to the server nodes 120, profile information indicative of resources primarily used by each workload, and the status of completion of each workload. The illustrative environment 400 also includes telemetry data 404, which may be embodied as data indicative of the utilizations of each monitored resource in each server node 120 (e.g., percentage of available CPU 302 processing capacity presently used, number of operations per second, etc.). Additionally, the illustrative environment 400 includes channel utilization data 406 which may be embodied as any data indicative of the amount of network traffic presently on the communication link between each server node 120 and the network switch 110, and the amount of remaining bandwidth available for utilization. Further, in the illustrative embodiment, the environment 400 includes quality of service data 408 indicative of one or more quality of service objectives (e.g., a throughput, a latency, a target amount of time to complete a workload, etc.) to be satisfied during the execution of the workloads and the present quality of service provided by the system 100. The quality of service objectives may be obtained from workload requests from the client device 130, as described herein, or may be preconfigured (e.g., based on a service level agreement between the operator of the client device 130 and the operator of the system 100). The present quality of service provided by the system 100 may be determined by the network switch 110 from the workload data 402 (e.g., status of completion of the workloads) and the telemetry data 404 (e.g., operations per second, etc.).

In the illustrative environment 400, the network communicator 420, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the network switch 110, respectively. To do so, the network communicator 420 is configured to receive and process data packets from one system or computing device (e.g., the client device 130) and to prepare and send data packets to another computing device or system (e.g., the server nodes 120). Accordingly, in some embodiments, at least a portion of the functionality of the network communicator 420 may be performed by the communication circuitry 210, and, in the illustrative embodiment, by the port logics 212.

The workload distribution manager 430, which may be embodied as hardware, firmware, software, virtualized hardware, emulated architecture, and/or a combination thereof as discussed above, is configured to receive requests from the client device 130 to perform workloads, monitor the telemetry data 404 and channel utilization data 406 to determine the available capacity of the resources of the server nodes 120 and their available communication bandwidths, determine the quality of service objective(s) and the present quality of service provided by the server nodes 120, and select which server nodes 120 to assign workload to, to satisfy the quality of service objective(s). To do so, in the illustrative embodiment, the workload distribution manager 430 includes a request manager 432, a telemetry monitor 434, and a load balancer 436. The request manager 432, in the illustrative embodiment, is configured to receive requests from the client device 130 to perform workloads and parse parameters out of the requests to determine additional information, such as a designation of one or more of the server nodes 120 to perform each workload, a type of resource that will be most impacted by execution of the workload (e.g., that the workload is CPU intensive, memory intensive, accelerator intensive, etc.), referred to herein as a resource sensitivity of the workload, and a quality of service objective associated with the execution of the workload (e.g., a maximum amount of time in which to complete the workload, a target number of operations per second, a latency, a preference to not be assigned to a server node 120 in which the utilization of one or more of the resources is already at or in excess of a specified threshold, etc.). The telemetry monitor 434, in the illustrative embodiment, is configured to receive updates from the server nodes 120 with updated telemetry data 404. The telemetry monitor 434, in the illustrative embodiment, may parse and categorize the telemetry data 404, such as by separating the telemetry data 404 into an individual file or data set for each server node 120. The load balancer 436, in the illustrative embodiment, is configured to execute a load balancing algorithm using the telemetry data 404 and the channel utilization data 406 to determine the available capacities of the various server nodes 120 at any given time, determine the present quality of service provided by the system 100, and select which of the server nodes 120 should perform a given workload based on the available capacities of the server nodes 120 and the quality of service data 408. In the illustrative embodiment, the functions of the load balancer 436 are performed by the load balancer logic 204 of FIG. 2. Further, in the illustrative embodiment, the load balancer 436 includes a workload assignor 438, which is configured to assign a given workload to one or more of the server nodes 120 according to the determinations made by the load balancer 436. The workload assignor 438 may assign a workload by sending an identifier of the workload and/or a file, code, or data embodying the workload to the one or more server nodes 120 that have been selected execute the workload.

It should be appreciated that each of the request manager 432, the telemetry monitor 434, the load balancer 436, and the workload assignor 438 may be separately embodied as hardware, firmware, software, virtualized hardware, emulated architecture, and/or a combination thereof. For example, the request manager 432 may be embodied as a hardware component, while the telemetry monitor 434, the load balancer 436, and the workload assignor 438 are embodied as virtualized hardware components or as some other combination of hardware, firmware, software, virtualized hardware, emulated architecture, and/or a combination thereof.

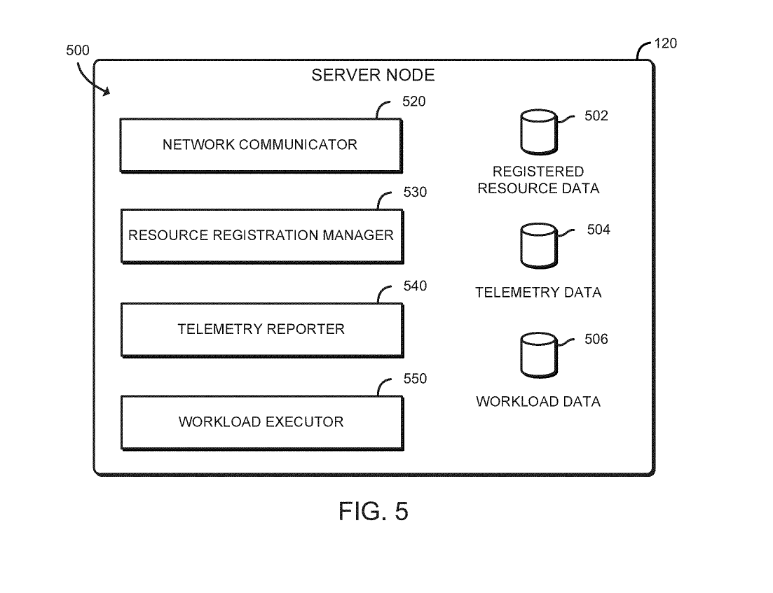

Referring now to FIG. 5, in the illustrative embodiment, each server node 120 may establish an environment 500 during operation. The illustrative environment 500 includes a network communicator 520, a resource registration manager 530, a telemetry reporter 540, and a workload executor 550. Each of the components of the environment 500 may be embodied as hardware, firmware, software, or a combination thereof. As such, in some embodiments, one or more of the components of the environment 500 may be embodied as circuitry or a collection of electrical devices (e.g., network communicator circuitry 520, resource registration manager circuitry 530, telemetry reporter circuitry 540, workload executor circuitry 550, etc.). It should be appreciated that, in such embodiments, one or more of the network communicator circuitry 520, resource registration manager circuitry 530, telemetry reporter circuitry 540, or workload executor circuitry 550 may form a portion of one or more of the CPU 302, the main memory 304, the I/O subsystem 306, the communication circuitry 308, the one or more accelerators 314, and/or other components of the server node 120. In the illustrative embodiment, the environment 500 includes registered resource data 502, which may be embodied as any data indicative of resources, including physical resources (e.g., the CPU 302, the memory 304, the one or more accelerators 314, the one or more data storage devices 320) and/or software resources (e.g., a database) whose identity (e.g., a unique identifier), type (e.g., compute, memory, etc.), capabilities (e.g., maximum frequency, maximum operations per second, etc.) and utilization (e.g., load) at any given time is to be reported to the network switch 110. Additionally, the illustrative environment 500 includes telemetry data 504, which is similar to the telemetry data 404 of FIG. 4, except it pertains to the resources of the present server node 120 rather than multiple server nodes 120. The illustrative environment 500 additionally includes workload data 506, which is similar to the workload data 402 of FIG. 4, except the workload data 506 pertains to the workloads assigned to the present server node 120 rather than all of the server nodes 120.

In the illustrative environment 500, the network communicator 520, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the server node 120, respectively. To do so, the network communicator 520 is configured to receive and process data packets from one system or computing device (e.g., the network switch 110) and to prepare and send data packets to a computing device or system (e.g., the network switch 110 and/or other server nodes 120). Accordingly, in some embodiments, at least a portion of the functionality of the network communicator 520 may be performed by the communication circuitry 308, and, in the illustrative embodiment, by the host fabric interface 310.

In the illustrative environment 500, the resource registration manager 530, which may be embodied as hardware, firmware, software, virtualized hardware, emulated architecture, and/or a combination thereof as discussed above, is configured to identify hardware and software resources of the server node 120 to be monitored and to generate the registered resource data 502. Further, in the illustrative environment 500, the telemetry reporter 540, which may be embodied as hardware, firmware, software, virtualized hardware, emulated architecture, and/or a combination thereof as discussed above, is configured to send updates to the network switch 110 indicative of changes in the resource utilizations of the resources. The telemetry reporter 540 may send updates on a periodic basis and/or in response to receiving a message from a software stack (e.g., the kernel, a driver, an application, etc.) executed by the server node 120 that the utilization of one or more resources has changed. In the illustrative embodiment, the telemetry reporter 540 is implemented by the telemetry logic 312 of FIG. 3. Further, in the illustrative embodiment, the workload executor 550 which may be embodied as hardware, firmware, software, virtualized hardware, emulated architecture, and/or a combination thereof as discussed above, is configured to execute the assigned workloads using the resources of the server node 120.

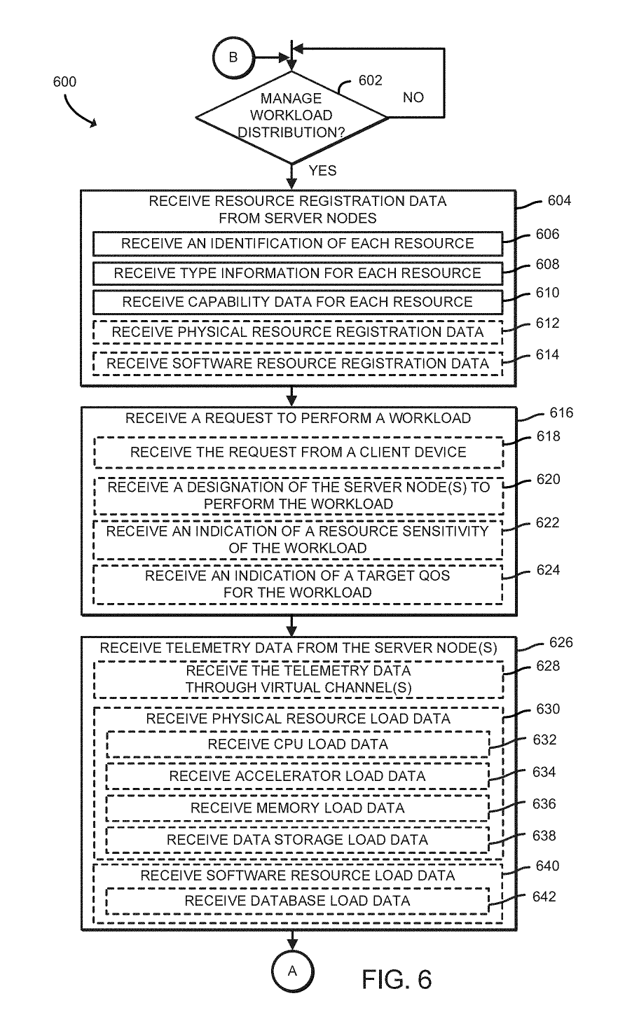

Referring now to FIG. 6, in use, the network switch 110 may execute a method 600 for managing the distribution of workloads among server nodes 120. In the illustrative embodiment, the network switch 110 performs the method 600 while concurrently receiving messages from computers and routing the messages to destination computers (e.g., routing packets among the server nodes 120 using the multiple port logics 212). The method 600 begins with block 602 in which the network switch 110 determines whether to manage the distribution of workloads among the server nodes 120. In the illustrative embodiment, the network switch 110 determines to manage the distribution of workloads if the network switch 110 is powered on and in communication with the server nodes 120. In other embodiments, the network switch 110 may determine whether to manage the distribution of workloads based on other factors, such as whether the network switch 110 has received an instruction from an administrator to do, based on an instruction in a configuration file, etc. Regardless, in response to a determination to manage the distribution of workloads, the method 600 advances to block 604 in which the network switch 110 receives resource registration data from the server nodes 120. The resource registration data may be embodied as any data indicative of resources whose utilizations are to be monitored during the operation of the server nodes 120 to facilitate load balancing (e.g., the selection of which server nodes 120 should perform which workloads). In doing so, the network switch 110 receives an identification (e.g., a unique identifier) of each resource, as indicated in block 606. Additionally, as indicated in block 608, the network switch 110 receives type information for each resource. The type information may be embodied as any information indicative of whether the resource is a physical resource (e.g., a CPU, a memory, an accelerator, etc.) or a software resource (e.g., a database) and the general functions the resource performs (e.g., calculations, data storage and retrieval, etc.). Further, in the illustrative embodiment, the network switch 110 receives capability data for each resource, as indicated in block 610. The capability data may be embodied as any data indicative of the capacity of the resource to perform one or more functions (e.g., a number of operations per second, the number of cores, and/or the frequency of a CPU, the amount of memory available and the latency of accesses to the memory, etc.). In receiving the resource registration data, the network switch 110 may receive physical resource registration data, as indicated in block 612 and/or software resource registration data, as indicated in block 614.

Subsequently, the method 600 advances to block 616 in which the network switch 110 receives a request to perform a workload. In doing so, the network switch 110 may receive the request from the client device 130, as indicated in block 618. Additionally, in receiving the request, the network switch 110, may receive a designation of one or more of the server nodes 120 to perform the workload, as indicated in block 620. The designation may be included as a parameter in the request. Additionally or alternatively, the network switch 110 may receive an indication of a resource sensitivity of the workload, as indicated in block 622. The indication of the resource sensitivity of the workload may be included as a parameter of the request and, in the illustrative embodiment, indicates one or more types of resources that are likely to be most heavily impacted by the execution of the workload. As such, for a workload that makes intense (e.g., above a predefined threshold) use of the CPU, the resource sensitivity may indicate “CPU”. Similarly, if the workload is memory intensive, the resource sensitivity may indicate “memory”. In the illustrative embodiment, the resource sensitivity may specify multiple resource types that are likely to be heavily used (e.g., “CPU +memory”). Further, as indicated in block 624, in receiving the request, the network switch 110 may receive an indication of a target quality of service (i.e., a quality of service objective) to be satisfied during the execution of the workload, such as a target amount of time in which to complete the workload, an instruction to assign the workload to a server node 120 having a resource utilization for one or more specified types of resources that satisfies a specified threshold (e.g., an instruction to assign the workload to a server node 120 having a CPU utilization that is below 50%), and/or other measures of the target quality of service to be provided.

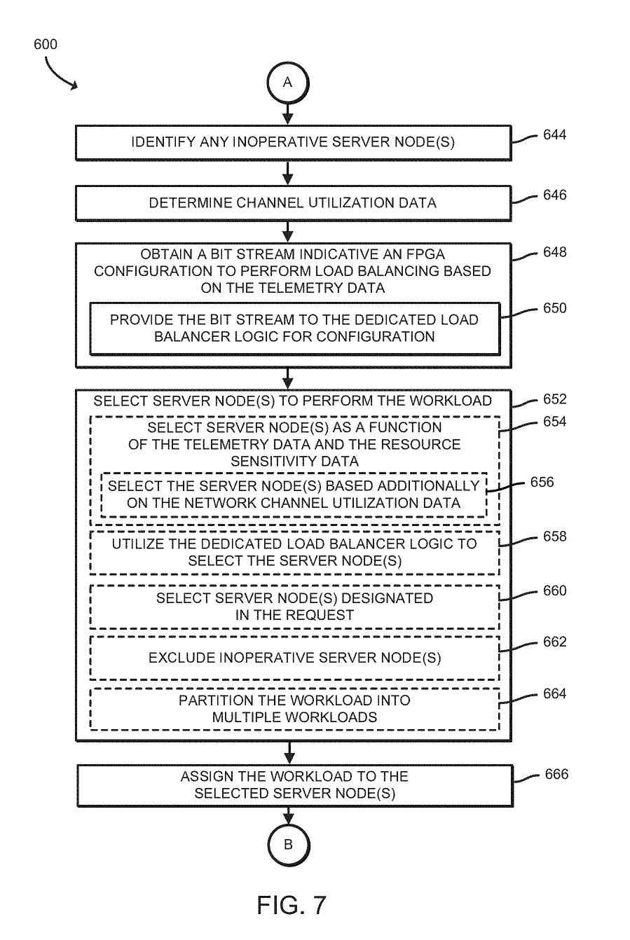

Afterwards, the method 600 advances to block 626 in which the network switch 110 receives the telemetry data 404 from the server nodes 120. In doing so, the network switch 110 may receive the telemetry data 404 through a virtual channel established with each of the server nodes 120, as indicated in block 628. Additionally, in receiving the telemetry data 404, the network switch 110 may receive telemetry data 404 pertaining to one or more physical resources, as indicated in block 630. In receiving the telemetry data 404 associated with one or more physical resources, the network switch 110 may receive CPU load data indicative of the present utilization of the CPU 302 of the server node 120 (e.g., a percentage of the available CPU capacity presently used, such as a percentage of the available operations per second or the percentage of the total number of cores that are presently being used), as indicated in block 632. Similarly, as indicated in block 634, the network switch 110 may receive accelerator load data which may be embodied as any data indicative of the present utilization of the accelerators 314 available in the server node 120 (e.g., a percentage of the total capacity). Additionally or alternatively, as indicated in block 636, the network switch 110 may receive memory load data which may be embodied as any data indicative of the present utilization of the memory 304 available in the server node 120 (e.g., a percentage of the total capacity). As indicated in block 638, the network switch 110 may receive data storage load data which may be embodied as any data indicative of the present utilization of the data storage devices 320 of the server node 120 (e.g., a percentage of the total capacity). The network switch 110 may receive software resource load data, as indicated in block 640. The software resource load data may be embodied as any data indicative of the present utilization of one or more software resources of the server node 120. For example, as indicated in block 642, the network switch 110 may receive database load data indicative of the present utilization of the database of the server node 120 (e.g., the percentage of the total capacity of the database that is presently being used, the number of pending database requests that have not been completed yet, the average time that elapses to complete a request, etc.). Subsequently, the method 600 advances to block 644 of FIG. 7, in which the network switch 110 identifies any inoperative server nodes 120. While the operations of method 600 are described in a particular order above, it should be understood that in other embodiments, the operations may be performed in a different order (e.g., the telemetry data 404 may be received before the request to perform a workload, etc.).

Referring now to FIG. 7, in identifying inoperative server nodes 120, the network switch 110 may determine that a server node 120 is inoperative if the server node 120 has not transmitted a telemetry update or other data to the network switch 110 within a predefined time period and/or if the server node 120 has affirmatively sent a message to inform the network switch 110 that the server node 120 is not available for operation (e.g., due to maintenance operations). In block 646, the network switch 110 determines the channel utilization for each server node 120. Given that each server node 120 communicates with other computing devices through the network switch 110, the network switch 110 may readily determine the amount of data communicated to and from each server node 120. The network switch 110 may also have access to a total capacity of each channel (e.g., bits per second) and may determine the percentage of the total capacity of the channel that is being used at any given time. Furthermore, the network switch 110 may determine other data indicative of the status of the communication channel, including the latency in sending and receiving data, a percentage of packets lost during communications, and/or other information.

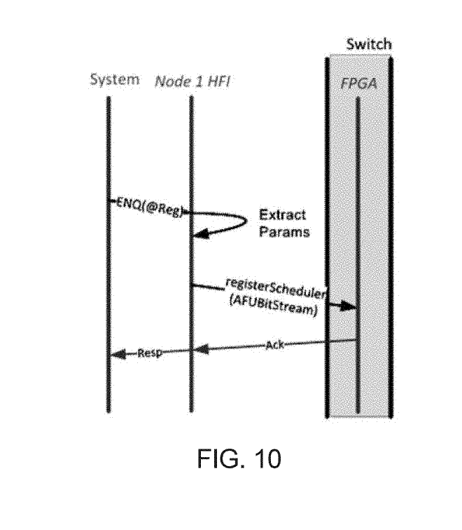

In the illustrative embodiment, the network switch 110 obtains a bit stream indicative of an FPGA configuration to perform a load balancing algorithm based at least on the telemetry data 404, as indicated in block 648. It should be understood that in some embodiments, the load balancing algorithm may be retrieved once at initialization, periodically, in response to each workload request, the first time of a particular request type, or due to changing conditions (e.g., the load balancing may be different when the server nodes 120 are more heavily loaded than when they are less heavily loaded, etc.). In the illustrative embodiment, the network switch 110 provides the bit stream to the dedicated load balancer logic 204 for configuration, as indicated in block 650. As described above, in the illustrative embodiment, the load balancer logic 204 is embodied as an FPGA to enable the network switch 110 to perform the load balancing (e.g., selection of server nodes 120 to execute workloads) more efficiently than if the load balancing was performed by the CPU 202. Referring now to FIG. 10, the bit stream may be provided, at least in part, by another computing device in the system 100, such as from one of the server nodes 120. In some embodiments, each server node 120 may contribute a portion of the bit stream, with information indicative of how to perform load balancing based on information provided by the particular server node 120 (e.g., how to parse the telemetry data 404, etc.). In FIG. 10, the operating system or kernel of the one of the server nodes 120 provides a message to the HFI 310 of the server node 120. The HFI 310, and more particularly, the telemetry logic 312, extracts parameters from the message and transmits a corresponding bit stream to the network switch 110, which then sends an acknowledgement message to the HFI 310 of the server node 120. The HFI 310 then sends a response message to the operating system or kernel indicating completion of the operation.

Referring again to FIG. 7, in block 652, the network switch 110 selects one or more of the server nodes 120 to perform the workload from the request received in block 616 of FIG. 6. In doing so, the network switch 110, in the illustrative embodiment, selects the one or more server nodes 120 as a function of the telemetry data 404 and the channel utilization data 406, as indicated in block 654. Further, as indicated in block 656, the network switch 110 selects the one or more server nodes 120 based additionally on the resource sensitivity indicated in the request, as described in block 622 of FIG. 6. In the illustrative embodiment, the network switch 110 utilizes the dedicated load balancer logic 204 to select the one or more server nodes 120 to execute the workload, as indicated in block 658. In selecting the one or more server nodes 120, the network switch 110 may select or give preference to one or more server nodes 120 designated in the request, as indicated in block 660. Further, the network switch 110, in the illustrative embodiment, excludes inoperative server nodes 120, identified in block 644, from the set of server nodes 120 that may receive the workload, as indicated in block 662. The algorithm executed for load balancing may be embodied as an initial determination as to which of the server nodes 120 would be able to execute the workload in satisfaction of the quality of service objective(s) associated with the workload (e.g., specified in the request, specified in a service level agreement for the client, or a default quality of service objective for the data center). For example, the network switch 110 may initially determine that all of the server nodes 110 would be able to perform the workload in satisfaction of the quality of service objective(s). Next, the network switch 110 may analyze the telemetry data 404 for each server node 110, and if the present utilization of a resource that is likely to be most affected by the workload (e.g., as indicated by the resource sensitivity of the workload) is greater than a predefined threshold (e.g., 60%), the network switch 110 may determine that the corresponding server node 110 would be unable to satisfy the quality of service objective(s). Of the server nodes 120 determined to be able to satisfy the quality of service objective(s), the network switch 110, in the illustrative embodiment, may then identify the server nodes 120 with the lowest amount of channel utilization (e.g., the least amount of network congestion) as the best candidates. Further, if one or more of the server nodes 120 in the remaining set were designated in the request, then the network switch 110 may select the designated one or more server nodes 120. Otherwise, the network switch 110 may ignore the designation of server nodes 120 in the request and select one of the remaining best candidates (e.g., randomly or based on any other selection method) to execute the workload. In other embodiments, the load balancing algorithm may be different. Additionally, as indicated in block 664, the network switch 110 may partition the workload into multiple workloads to be executed concurrently by different server nodes 120 (e.g., if the network switch 110 determines that assigning a complete workload would result in a resource utilization of a server node 120 that would reduce the quality of service below a predefined threshold). Afterwards, the network switch 110 assigns the workload, or the various partitions of the workload, to the selected one or more server nodes 120, as indicated in block 666. Subsequently, the method 600 loops back to block 602 of FIG. 6, in which the network switch 110 determines whether to continue managing the distribution of workloads among the server nodes 120.

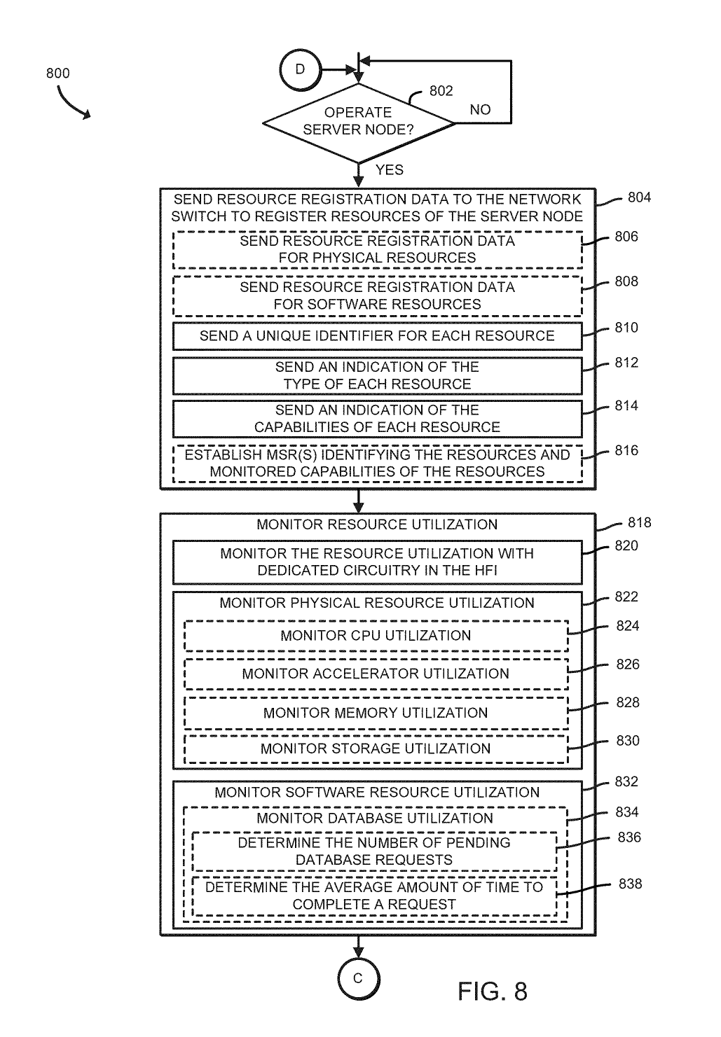

Referring now to FIG. 8, in use, each server node 120 may execute a method 800 for reporting telemetry data and executing workloads. The method 800 begins with block 802 in which the server node 120 determines whether to report telemetry data and execute workloads. In the illustrative embodiment, the server node 120 determines to report telemetry data and execute workloads if the server node 120 is powered on and in communication with the network switch 110. In other embodiments, the server node 120 may determine whether to report telemetry data and execute workloads based on other factors. Regardless, in response to a determination to proceed, the method 800 advances to block 804 in which the server node 120 sends resource registration data to the network switch to register resources of the server node 120. In doing so, the server node 120 may send resource registration data for physical resources (e.g., the CPU 302, the memory 304, the one or more accelerators 314, the one or more data storage devices 320, etc.), as indicated in block 806. The server node 120 may also send resource registration data for one or more software resources, such as a database, as indicated in block 808. In sending the resource registration data, the server node 120 may send a unique identifier for each resource, as indicated in block 810. Further, as indicated in block 812, the server node 120 may send an indication of the type of each resource. Additionally, the server node 120 may send an indication of the capabilities of each resource, as indicated in block 814. Blocks 806 through 814 correspond with blocks 606 through 614 of FIG. 6. In the illustrative embodiment, the server node 120 also establishes one or more model specific registers (MSRs) that identify the resources and the capabilities of the resources, for access by software applications executed by the server node 120, as indicated in block 816. Further, in some embodiments, the server node 120 may query the network switch 110 to determine which types of metrics (e.g., CPU utilization, accelerator utilization, etc.) can be analyzed by the network switch 110 to perform load balancing, and may register the resources associated with the types of metrics reported by the network switch 110 in response to the query.

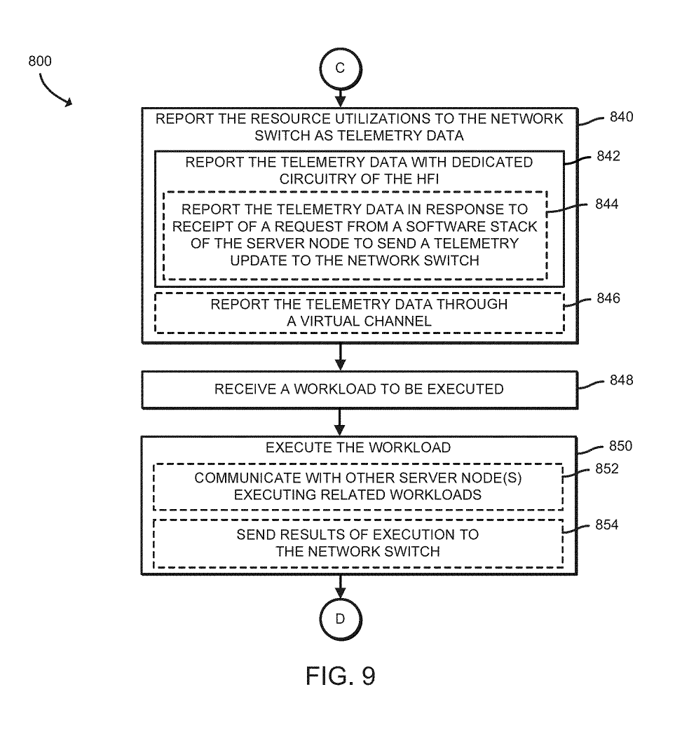

In block 818, the server node 120 monitors the utilization of the resources that were registered in block 804, such as by utilizing performance monitoring software (e.g., a “pmon” process) and/or performance counters. In doing so, in the illustrative embodiment, the server node 120 monitors the resource utilization with dedicated circuitry of the HFI 310 (e.g., the telemetry logic 312), as indicated in block 820. In monitoring the resource utilization, the server node 120, in the illustrative embodiment, monitors physical resource utilization, as indicated in block 822. In monitoring the physical resource utilization, the server node 120 may monitor the utilization of the CPU 302, as indicated in block 824, the utilization of the one or more accelerators 314, as indicated in block 826, the utilization of the memory 304, as indicated in block 828, and/or the utilization of the one or more data storage devices 320, as indicated in block 830. The server node 120 may also monitor the utilization of one or more software resources, also referred to herein as “virtual resources”, as indicated in block 832. For example, in some embodiments, software on the server node 120 may report virtual resource utilizations (e.g., the load presently managed by software executed on the server node 120). In doing so, the server node 120 may monitor database utilization, as indicated in block 834. In monitoring the database utilization, the server node 120 (e.g., database software executed on the server node 120) may determine the number of pending database requests (e.g., requests that have not been completed yet), as indicated in block 836. Additionally or alternatively, the server node 120 (e.g., database software on the server node 120) may determine the average amount of time that elapses to complete a request (e.g., to retrieve data or to store data), as indicated in block 838. Subsequently, the method 800 advances to block 840 of FIG. 9, in which the server node 120 (e.g., the software on the server node 120 associated with the virtual resource(s)) reports the resource utilizations to the network switch 110 as the telemetry data 504.

Referring now to FIG. 9, in reporting the resource utilizations as telemetry data 504, the server node 120, in the illustrative embodiment, reports the resource utilizations with dedicated circuitry of the HFI 310 (e.g., the telemetry logic 312), as indicated in block 842. In doing so, the telemetry logic 312, in the illustrative embodiment, reports the telemetry data 504 in response to receiving a request from a software stack of the server node 120 to send a telemetry update to the network switch 110 (e.g., a request generated in response to a change in the utilization of one or more of the monitored resources), as indicated in block 844. In the illustrative embodiment, the server node 120 reports the telemetry data 504 through a virtual channel to the network switch 110, as indicated in block 846.

In block 848, the server node 120 receives, from the network switch (e.g., as a result of a selection of the server node 120 made at block 652 in FIG. 7) a workload to be executed and, in block 850, the server node 120 executes the workload. In other embodiments, the reporting of the resource utilizations may occur after receiving a workload to be executed. In executing the workload, the server node 120 may communicate with one or more other server nodes 120 that are executing related workloads (e.g., subsets of a larger workload that was partitioned by the network switch 110 in block 664 of FIG. 7), as indicated in block 852. The server node 120, in the illustrative embodiment, may send results of execution of the workload to the network switch 110 (e.g., to be provided to the client and/or to be combined with results from other server nodes 120). Subsequently, the method 800 loops back to block 802 of FIG. 8, in which the server node 120 determines whether to continue executing workloads and reporting telemetry data.

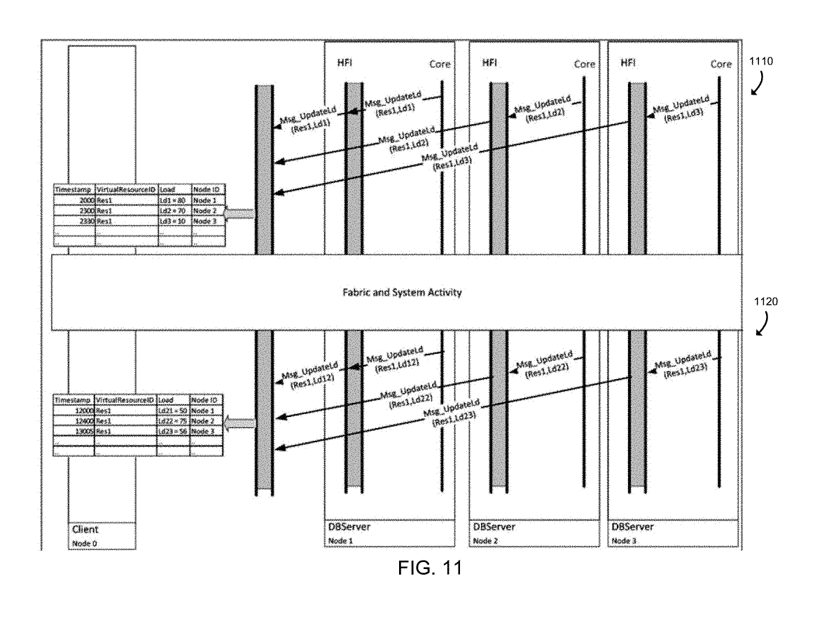

Referring now to FIG. 11, during a time period 1110, multiple server nodes 120 each send an update message (e.g., “Msg_UpdateLd”) to the network switch 110. Within each server node 120, the update message is initiated by a core (e.g., the operating system, kernel, or similar component) which sends an update regarding the utilization of a resource of the server node 120 to the HFI 310, which then sends the update message, using the dedicated telemetry logic 312, to the network switch 110. In the illustrative embodiment, the update message includes the resource identifier and the updated load (e.g., utilization) of the resource. The network switch 110, in response to receipt of the update messages, stores the updated data in a table that associates a time stamp of the update, the resource identifier, the load, and an identifier of the server node 120 to which the resource belongs. At a subsequent time period 1120, the server nodes 120 again send updates on the resource utilization to the network switch 110, and the network switch 110 stores the updated data in the table.

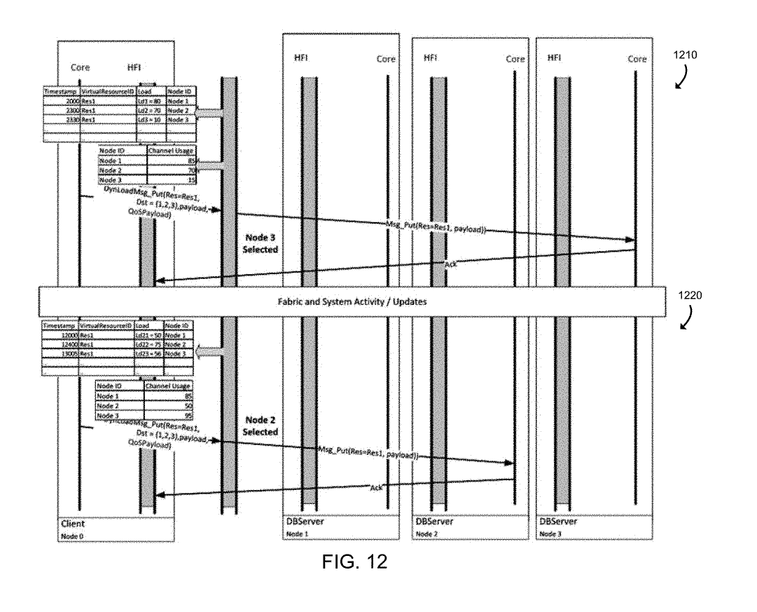

Referring now to FIG. 12, during a time period 1210 subsequent to the time period 1110, but prior to the time period 1120, the network switch 110 receives a request from the client device 130 to perform a workload. The request indicates that the resource sensitivity for the workload is “Res1” (e.g., the memory 304), meaning execution of the workload is likely to affect the load on the memory 304 of a server node 120 more significantly than any other type of resource. Additionally, the request designates the first, second, and third server nodes 122, 124, 126 in order of preference, to perform the workload. Further, the request includes a payload (e.g., the workload), and a quality of service target to be satisfied during the execution of the payload. In response, the network switch 110 determines that the third server node 126 has a lower load on the memory 304 and has a lower channel usage than the first and second server nodes 122, 124. Accordingly, the network switch 110 selects the third server node 126 to execute the workload and assigns the workload to the third server node 126 (e.g., by sending a “Msg_Put” message to the third server node 126). During a subsequent time period 1220, after the time period 1120, the network switch 110 receives a subsequent workload request, with similar parameters as before. However, during the time period 1220, the channel usage of the third server node 126 has risen to 95%. As such, the network switch 110 instead assigns the workload to the second network node 124 (e.g., by sending a “Msg_Put” message to the second server node 124), which has a higher load on the memory 304 than both the first server node 122 and the third server node 126, but has a lower channel utilization than the first server node 122 and the third server node 126. In some embodiments, the network switch 110 may determine to assign a workload to multiple server nodes 120, as described with reference to block 664 of FIG. 7. For example, during time period 1220, the network switch 110 may determine to assign portions of the workload to the first and second server nodes 122 and 124 (e.g., by sending a corresponding “Msg_Put” message to each of the first server node 122 and the second server node 124).

### EXAMPLES

Illustrative examples of the technologies disclosed herein are provided below. An embodiment of the technologies may include any one or more, and any combination of, the examples described below.

Example 1 includes a network switch for managing distribution of workloads among a set of server nodes, the network switch comprising one or more processors; one or more memory devices having stored therein a plurality of instructions that, when executed, cause the network switch to receive a message; route the message to a destination computer; receive a request to perform a workload; receive telemetry data from a plurality of server nodes in communication with the network switch, wherein the telemetry data is indicative of a present load on one or more resources of each server node; determine channel utilization data for each of the server nodes, wherein the channel utilization data is indicative of a present amount of network bandwidth of the server node; select, as a function of the telemetry data and the channel utilization data, one or more of the server nodes to execute the workload; and assign the workload to the selected one or more server nodes.

Example 2 includes the subject matter of Example 1, and wherein to select the one or more server nodes comprises to select the one or more server nodes further as a function of a target quality of service to be satisfied in the execution of the workload.

Example 3 includes the subject matter of any of Examples 1 and 2, and wherein to receive the request to perform the workload comprises to receive an indication of a resource sensitivity associated with the workload, wherein the resource sensitivity is indicative of one or more resources that the workload will primarily utilize when executed.

Example 4 includes the subject matter of any of Examples 1-3, and wherein to select the one or more server nodes comprises to utilize dedicated load balancer logic of the network switch to select the one or more server nodes.

Example 5 includes the subject matter of any of Examples 1-4, and wherein the dedicated load balancer logic comprises a field programmable gate array (FPGA) and the plurality of instructions, when executed, further cause the network switch to obtain a bit stream indicative of a configuration of the FPGA to perform a load balancing operation; and provide the bit stream to the FPGA to configure the FPGA to perform the load balancing operation.

Example 6 includes the subject matter of any of Examples 1-5, and wherein, when executed, the plurality of instructions further cause the network switch to identify one or more inoperative server nodes, and wherein to select one or more server nodes to perform the workload comprises to exclude the one or more inoperative server nodes from the selection.

Example 7 includes the subject matter of any of Examples 1-6, and wherein to receive the request comprises to receive a designation of one or more of the server nodes to perform the workload; and to select the one or more server nodes comprises to select one or more server nodes designated in the request.

Example 8 includes the subject matter of any of Examples 1-7, and wherein, when executed, the plurality of instructions further cause the network switch to receive resource registration data from the server nodes, wherein the resource registration data is indicative of a unique identifier for each resource, a type of each resource, and capabilities of each resource.

Example 9 includes the subject matter of any of Examples 1-8, and wherein to receive the resource registration data comprise to receive resource registration data associated with one or more physical resources of the server nodes.

Example 10 includes the subject matter of any of Examples 1-9, and wherein to receive the resource registration data comprises to receive resource registration data associated with one or more software resources of the server nodes.

Example 11 includes the subject matter of any of Examples 1-10, and wherein to receive the telemetry data comprise to receive the telemetry data through a virtual channel with each of the server nodes.

Example 12 includes the subject matter of any of Examples 1-11, and wherein to receive the telemetry data comprises to receive load data indicative of a load on one or more physical resources of the one or more server nodes.

Example 13 includes the subject matter of any of Examples 1-12, and wherein to receive the telemetry data indicative of a load on one or more physical resources comprises to receive load data indicative of a load on or more of a central processing unit, an accelerator, a memory, and a data storage device of the one or more server nodes.

Example 14 includes the subject matter of any of Examples 1-13, and wherein to receive the telemetry data comprises to receive load data indicative of a load on one or more software resources of the one or more server nodes.

Example 15 includes a method for managing distribution of workloads among a set of server nodes, the method comprising receiving, by a network switch, a message; routing, by the network switch, the message to a destination computer; receiving, by a network switch, a request to perform a workload; receiving, by the network switch, telemetry data from a plurality of server nodes in communication with the network switch, wherein the telemetry data is indicative of a present load on one or more resources of each server node; determining, by the network switch, channel utilization data for each of the server nodes, wherein the channel utilization data is indicative of a present amount of network bandwidth of the server node; selecting, by the network switch and as a function of the telemetry data and the channel utilization data, one or more of the server nodes to execute the workload; and assigning, by the network switch, the workload to the selected one or more server nodes.

Example 16 includes the subject matter of Example 15, and wherein selecting the one or more server nodes comprises selecting the one or more server nodes further as a function of a target quality of service to be satisfied in the execution of the workload.

Example 17 includes the subject matter of any of Examples 15 and 16, and wherein receiving the request to perform the workload comprises receiving an indication of a resource sensitivity associated with the workload, wherein the resource sensitivity is indicative of one or more resources that the workload will primarily utilize when executed.

Example 18 includes the subject matter of any of Examples 15-17, and wherein selecting the one or more server nodes comprises utilizing dedicated load balancer logic of the network switch to select the one or more server nodes.

Example 19 includes the subject matter of any of Examples 15-18, and wherein the dedicated load balancer logic includes a field programmable gate array (FPGA), the method further comprising obtaining, by the network switch, a bit stream indicative of a configuration of the FPGA to perform a load balancing operation; and providing, by the network switch, the bit stream to the FPGA to configure the FPGA to perform the load balancing operation.

Example 20 includes the subject matter of any of Examples 15-19, and further including identifying, by the network switch, one or more inoperative server nodes, and wherein selecting one or more server nodes to perform the workload comprises excluding the one or more inoperative server nodes from the selection.

Example 21 includes the subject matter of any of Examples 15-20, and wherein receiving the request comprises receiving a designation of one or more of the server nodes to perform the workload; and selecting the one or more server nodes comprises selecting one or more server nodes designated in the request.

Example 22 includes the subject matter of any of Examples 15-21, and further including receiving, by the network switch, resource registration data from the server nodes, wherein the resource registration data is indicative of a unique identifier for each resource, a type of each resource, and capabilities of each resource.

Example 23 includes the subject matter of any of Examples 15-22, and wherein receiving the resource registration data comprises receiving resource registration data associated with one or more physical resources of the server nodes.

Example 24 includes the subject matter of any of Examples 15-23, and wherein receiving the resource registration data comprises receiving resource registration data associated with one or more software resources of the server nodes.

Example 25 includes the subject matter of any of Examples 15-24, and wherein receiving the telemetry data comprises receiving the telemetry data through a virtual channel with each of the server nodes.

Example 26 includes the subject matter of any of Examples 15-25, and wherein receiving the telemetry data comprises receiving load data indicative of a load on one or more physical resources of the one or more server nodes.

Example 27 includes the subject matter of any of Examples 15-26, and wherein receiving the telemetry data indicative of a load on one or more physical resources comprises receiving load data indicative of a load on or more of a central processing unit, an accelerator, a memory, and a data storage device of the one or more server nodes.

Example 28 includes the subject matter of any of Examples 15-27, and wherein receiving the telemetry data comprises receiving load data indicative of a load on one or more software resources of the one or more server nodes.

Example 29 includes a network switch for managing distribution of workloads among a set of server nodes, the network switch comprising means for performing the method of any of Examples 15-28.

Example 30 includes a network switch for managing distribution of workloads among a set of server nodes, the network switch comprising one or more processors; one or more memory devices having stored therein a plurality of instructions that, when executed, cause the network switch to perform the method of any of Examples 15-28.

Example 31 includes one or more machine-readable storage media comprising a plurality of instructions stored thereon that, in response to being executed, cause a network switch to perform the method of any of Examples 15-28.

Example 32 includes a network switch for managing distribution of workloads among a set of server nodes, the network switch comprising network communicator circuitry to receive a message, route the message to a destination computer, and receive a request to perform a workload; and workload distribution manager circuitry to receive telemetry data from a plurality of server nodes in communication with the network switch, wherein the telemetry data is indicative of a present load on one or more resources of each server node, determine channel utilization data for each of the server nodes, wherein the channel utilization data is indicative of a present amount of network bandwidth of the server node, select, as a function of the telemetry data and the channel utilization data, one or more of the server nodes to execute the workload, and assign the workload to the selected one or more server nodes.

Example 33 includes the subject matter of Example 32, and wherein to select the one or more server nodes comprises to select the one or more server nodes further as a function of a target quality of service to be satisfied in the execution of the workload.

Example 34 includes the subject matter of any of Examples 32 and 33, and wherein to receive the request to perform the workload comprises to receive an indication of a resource sensitivity associated with the workload, wherein the resource sensitivity is indicative of one or more resources that the workload will primarily utilize when executed.

Example 35 includes the subject matter of any of Examples 32-34, and wherein to select the one or more server nodes comprises to utilize dedicated load balancer logic of the network switch to select the one or more server nodes.

Example 36 includes the subject matter of any of Examples 32-35, and wherein the dedicated load balancer logic comprises a field programmable gate array (FPGA) and the workload distribution manager circuitry is further to obtain a bit stream indicative of a configuration of the FPGA to perform a load balancing operation; and provide the bit stream to the FPGA to configure the FPGA to perform the load balancing operation.

Example 37 includes the subject matter of any of Examples 32-36, and wherein the workload distribution manager circuitry is further to identify one or more inoperative server nodes, and wherein to select one or more server nodes to perform the workload comprises to exclude the one or more inoperative server nodes from the selection.

Example 38 includes the subject matter of any of Examples 32-37, and wherein to receive the request comprises to receive a designation of one or more of the server nodes to perform the workload; and to select the one or more server nodes comprises to select one or more server nodes designated in the request.

Example 39 includes the subject matter of any of Examples 32-38, and wherein the network communicator circuitry is further to receive resource registration data from the server nodes, wherein the resource registration data is indicative of a unique identifier for each resource, a type of each resource, and capabilities of each resource.

Example 40 includes the subject matter of any of Examples 32-39, and wherein to receive the resource registration data comprise to receive resource registration data associated with one or more physical resources of the server nodes.

Example 41 includes the subject matter of any of Examples 32-40, and wherein to receive the resource registration data comprises to receive resource registration data associated with one or more software resources of the server nodes.

Example 42 includes the subject matter of any of Examples 32-41, and wherein to receive the telemetry data comprise to receive the telemetry data through a virtual channel with each of the server nodes.

Example 43 includes the subject matter of any of Examples 32-42, and wherein to receive the telemetry data comprises to receive load data indicative of a load on one or more physical resources of the one or more server nodes.

Example 44 includes the subject matter of any of Examples 32-43, and wherein to receive the telemetry data indicative of a load on one or more physical resources comprises to receive load data indicative of a load on or more of a central processing unit, an accelerator, a memory, and a data storage device of the one or more server nodes.

Example 45 includes the subject matter of any of Examples 32-44, and wherein to receive the telemetry data comprises to receive load data indicative of a load on one or more software resources of the one or more server nodes.

Example 46 includes a network switch for managing distribution of workloads among a set of server nodes, the network switch comprising circuitry for receiving a message; circuitry for routing the message to a destination computer; circuitry for receiving a request to perform a workload; circuitry for receiving telemetry data from a plurality of server nodes in communication with the network switch, wherein the telemetry data is indicative of a present load on one or more resources of each server node; circuitry for determining channel utilization data for each of the server nodes, wherein the channel utilization data is indicative of a present amount of network bandwidth of the server node; means for selecting, as a function of the telemetry data and the channel utilization data, one or more of the server nodes to execute the workload; and circuitry for assigning the workload to the selected one or more server nodes.

Example 47 includes the subject matter of Example 46, and wherein the means for selecting the one or more server nodes comprises means for selecting the one or more server nodes further as a function of a target quality of service to be satisfied in the execution of the workload.

Example 48 includes the subject matter of any of Examples 46 and 47, and wherein the circuitry for receiving the request to perform the workload comprises circuitry for receiving an indication of a resource sensitivity associated with the workload, wherein the resource sensitivity is indicative of one or more resources that the workload will primarily utilize when executed.

Example 49 includes the subject matter of any of Examples 46-48, and wherein the means for selecting the one or more server nodes comprises means for utilizing dedicated load balancer logic of the network switch to select the one or more server nodes.

Example 50 includes the subject matter of any of Examples 46-49, and wherein the dedicated load balancer logic comprises a field programmable gate array (FPGA), the network switch further comprising circuitry for obtaining a bit stream indicative of a configuration of the FPGA to perform a load balancing operation; and circuitry for providing the bit stream to the FPGA to configure the FPGA to perform the load balancing operation.

Example 51 includes the subject matter of any of Examples 46-50, and further including circuitry to identify one or more inoperative server nodes, and wherein the means for selecting one or more server nodes to perform the workload comprises means for excluding the one or more inoperative server nodes from the selection.

Example 52 includes the subject matter of any of Examples 46-51, and wherein the circuitry for receiving the request comprises circuitry for receiving a designation of one or more of the server nodes to perform the workload; and the means for selecting the one or more server nodes comprises means for selecting one or more server nodes designated in the request.

Example 53 includes the subject matter of any of Examples 46-52, and further including circuitry for receiving resource registration data from the server nodes, wherein the resource registration data is indicative of a unique identifier for each resource, a type of each resource, and capabilities of each resource.

Example 54 includes the subject matter of any of Examples 46-53, and wherein the circuitry for receiving the resource registration data comprises circuitry for receiving resource registration data associated with one or more physical resources of the server nodes.

Example 55 includes the subject matter of any of Examples 46-54, and wherein the circuitry for receiving the resource registration data comprises circuitry for receiving resource registration data associated with one or more software resources of the server nodes.

Example 56 includes the subject matter of any of Examples 46-55, and wherein the circuitry for receiving the telemetry data comprise circuitry for receiving the telemetry data through a virtual channel with each of the server nodes.

Example 57 includes the subject matter of any of Examples 46-56, and wherein the circuitry for receiving the telemetry data comprises circuitry for receiving load data indicative of a load on one or more physical resources of the one or more server nodes.

Example 58 includes the subject matter of any of Examples 46-57, and wherein the circuitry for receiving the telemetry data indicative of a load on one or more physical resources comprises circuitry for receiving load data indicative of a load on or more of a central processing unit, an accelerator, a memory, and a data storage device of the one or more server nodes.

Example 59 includes the subject matter of any of Examples 46-58, and wherein the circuitry for receiving the telemetry data comprises circuitry for receiving load data indicative of a load on one or more software resources of the one or more server nodes.

Example 60 includes a server node for executing workloads and reporting telemetry data, the server node comprising one or more processors; a host fabric interface coupled to the one or more processors; and one or more memory devices having stored therein a plurality of instructions that, when executed, cause the server node to monitor resource utilizations of one or more resources of the server node with dedicated circuitry of the host fabric interface; report the resource utilizations to a network switch as telemetry data with the dedicated circuitry of the host fabric interface; receive, from the network switch, a workload to be executed; and execute the workload.

Example 61 includes the subject matter of Example 60, and wherein, when executed, the plurality of instructions further cause the server node to establish one or more model-specific registers (MSRs) to store data indicative of the resources available in the server node and capabilities of the resources.

Example 62 includes the subject matter of any of Examples 60 and 61, and wherein, when executed, the plurality of instructions further cause the server node to send resource registration data to the network switch to register the one or more resources of the server node, wherein the resource registration data is indicative of a unique identifier for each resource, a type of each resource, and capabilities of each resource.

Example 63 includes the subject matter of any of Examples 60-62, and wherein to send the registration data comprises to send registration data for one or more physical resources of the server node.

Example 64 includes the subject matter of any of Examples 60-63, and wherein to send the registration data comprises to send registration data for one or more software resources of the server node.

Example 65 includes the subject matter of any of Examples 60-64, and wherein to monitor resource utilizations comprises to monitor the utilization of one or more physical resources of the server node.

Example 66 includes the subject matter of any of Examples 60-65, and wherein to monitor resource utilizations comprises to monitor the utilization of a central processing unit of the server node.

Example 67 includes the subject matter of any of Examples 60-66, and wherein to monitor resource utilizations comprises to monitor the utilization of an accelerator of the server node.

Example 68 includes the subject matter of any of Examples 60-67, and wherein to monitor resource utilizations comprises to monitor the utilization of a memory of the server node.

Example 69 includes the subject matter of any of Examples 60-68, and wherein to monitor resource utilizations comprises to monitor the utilization of one or more data storage devices of the server node.

Example 70 includes the subject matter of any of Examples 60-69, and wherein to monitor resource utilizations comprises to monitor the utilization of one or more software resources of the server node.

Example 71 includes the subject matter of any of Examples 60-70, and wherein to monitor the utilization of one or more software resources of the server node comprises to monitor the utilization of a database of the server node.

Example 72 includes the subject matter of any of Examples 60-71, and wherein to monitor the utilization of a database of the server node comprises to determine a number of incomplete database requests.

Example 73 includes the subject matter of any of Examples 60-72, and wherein to monitor the utilization of a database of the server node comprises to determine an average amount of time to complete a database request.

Example 74 includes the subject matter of any of Examples 60-73, and wherein to report the resource utilizations as telemetry data comprises to report the telemetry data in response to receipt of a request from a software stack of the server node to send a telemetry update to the network switch.

Example 75 includes the subject matter of any of Examples 60-74, and wherein to report the telemetry data comprises to report the telemetry data through a virtual channel.

Example 76 includes a method for executing workloads and reporting telemetry data, the method comprising monitoring, by a server node, resource utilizations of one or more resources of the server node with dedicated circuitry of a host fabric interface of the server node; reporting, by the dedicated circuitry of the host fabric interface of the server node, the resource utilizations to a network switch as telemetry data; receiving, by the server node, from the network switch, a workload to be executed; and executing, by the server node, the workload.

Example 77 includes the subject matter of Example 76, and further including establishing, by the server node, one or more model-specific registers (MSRs) to store data indicative of the resources available in the server node and capabilities of the resources.

Example 78 includes the subject matter of any of Examples 76 and 77, and further including sending, by the server node, resource registration data to the network switch to register the one or more resources of the server node, wherein the resource registration data is indicative of a unique identifier for each resource, a type of each resource, and capabilities of each resource.

Example 79 includes the subject matter of any of Examples 76-78, and wherein sending the registration data comprises sending registration data for one or more physical resources of the server node.

Example 80 includes the subject matter of any of Examples 76-79, and wherein sending the registration data comprises sending registration data for one or more software resources of the server node.

Example 81 includes the subject matter of any of Examples 76-80, and wherein monitoring resource utilizations comprises monitoring the utilization of one or more physical resources of the server node.

Example 82 includes the subject matter of any of Examples 76-81, and wherein monitoring resource utilizations comprises monitoring the utilization of a central processing unit of the server node.

Example 83 includes the subject matter of any of Examples 76-82, and wherein monitoring resource utilizations comprises monitoring the utilization of an accelerator of the server node.

Example 84 includes the subject matter of any of Examples 76-83, and wherein monitoring resource utilizations comprises monitoring the utilization of a memory of the server node.

Example 85 includes the subject matter of any of Examples 76-84, and wherein monitoring resource utilizations comprises monitoring the utilization of one or more data storage devices of the server node.

Example 86 includes the subject matter of any of Examples 76-85, and wherein monitoring resource utilizations comprises monitoring the utilization of one or more software resources of the server node.

Example 87 includes the subject matter of any of Examples 76-86, and wherein monitoring the utilization of one or more software resources of the server node comprises monitoring the utilization of a database of the server node.

Example 88 includes the subject matter of any of Examples 76-87, and wherein monitoring the utilization of a database of the server node comprises determining a number of incomplete database requests.

Example 89 includes the subject matter of any of Examples 76-88, and wherein monitoring the utilization of a database of the server node comprises determining an average amount of time to complete a database request.

Example 90 includes the subject matter of any of Examples 76-89, and wherein reporting the resource utilizations as telemetry data comprises reporting the telemetry data in response to receipt of a request from a software stack of the server node to send a telemetry update to the network switch.

Example 91 includes the subject matter of any of Examples 76-90, and wherein reporting the telemetry data comprises reporting the telemetry data through a virtual channel.

Example 92 includes a server node for executing workloads and reporting telemetry data, the server node comprising means for performing the method of any of Examples 76-91.

Example 93 includes a server node for executing workloads and reporting telemetry data, the server node comprising one or more processors; one or more memory devices having stored therein a plurality of instructions that, when executed, cause the server node to perform the method of any of Examples 76-91.

Example 94 includes one or more machine-readable storage media comprising a plurality of instructions stored thereon that, in response to being executed, cause a server node to perform the method of any of Examples 76-91.

Example 95 includes a server node for executing workloads and reporting telemetry data, the server node comprising telemetry reporter circuitry to monitor resource utilizations of one or more resources of the server node with dedicated circuitry of a host fabric interface and report the resource utilizations to a network switch as telemetry data with the dedicated circuitry of the host fabric interface; and workload executor circuitry to receive, from the network switch, a workload to be executed and execute the workload.

Example 96 includes the subject matter of Example 95, and further including resource registration manager circuitry to establish one or more model-specific registers (MSRs) to store data indicative of the resources available in the server node and capabilities of the resources.

Example 97 includes the subject matter of any of Examples 95 and 96, and further including resource registration manager circuitry to send resource registration data to the network switch to register the one or more resources of the server node, wherein the resource registration data is indicative of a unique identifier for each resource, a type of each resource, and capabilities of each resource.

Example 98 includes the subject matter of any of Examples 95-97, and wherein to send the registration data comprises to send registration data for one or more physical resources of the server node.

Example 99 includes the subject matter of any of Examples 95-98, and wherein to send the registration data comprises to send registration data for one or more software resources of the server node.

Example 100 includes the subject matter of any of Examples 95-99, and wherein to monitor resource utilizations comprises to monitor the utilization of one or more physical resources of the server node.

Example 101 includes the subject matter of any of Examples 95-100, and wherein to monitor resource utilizations comprises to monitor the utilization of a central processing unit of the server node.

Example 102 includes the subject matter of any of Examples 95-101, and wherein to monitor resource utilizations comprises to monitor the utilization of an accelerator of the server node.

Example 103 includes the subject matter of any of Examples 95-102, and wherein to monitor resource utilizations comprises to monitor the utilization of a memory of the server node.

Example 104 includes the subject matter of any of Examples 95-103, and wherein to monitor resource utilizations comprises to monitor the utilization of one or more data storage devices of the server node.

Example 105 includes the subject matter of any of Examples 95-104, and wherein to monitor resource utilizations comprises to monitor the utilization of one or more software resources of the server node.

Example 106 includes the subject matter of any of Examples 95-105, and wherein to monitor the utilization of one or more software resources of the server node comprises to monitor the utilization of a database of the server node.

Example 107 includes the subject matter of any of Examples 95-106, and wherein to monitor the utilization of a database of the server node comprises to determine a number of incomplete database requests.

Example 108 includes the subject matter of any of Examples 95-107, and wherein to monitor the utilization of a database of the server node comprises to determine an average amount of time to complete a database request.

Example 109 includes the subject matter of any of Examples 95-108, and wherein to report the resource utilizations as telemetry data comprises to report the telemetry data in response to receipt of a request from a software stack of the server node to send a telemetry update to the network switch.

Example 110 includes the subject matter of any of Examples 95-109, and wherein to report the telemetry data comprises to report the telemetry data through a virtual channel.

Example 111 includes a server node for executing workloads and reporting telemetry data, the server node comprising circuitry for monitoring resource utilizations of one or more resources of the server node with dedicated circuitry of a host fabric interface of the server node; circuitry for reporting, with the dedicated circuitry of the host fabric interface of the server node, the resource utilizations to a network switch as telemetry data; circuitry for receiving, from the network switch, a workload to be executed; and circuitry for executing the workload.

Example 112 includes the subject matter of Example 111, and further including circuitry for establishing one or more model-specific registers (MSRs) to store data indicative of the resources available in the server node and capabilities of the resources.

Example 113 includes the subject matter of any of Examples 111 and 112, and further including circuitry for sending resource registration data to the network switch to register the one or more resources of the server node, wherein the resource registration data is indicative of a unique identifier for each resource, a type of each resource, and capabilities of each resource.

Example 114 includes the subject matter of any of Examples 111-113, and wherein the circuitry for sending the registration data comprises circuitry for sending registration data for one or more physical resources of the server node.

Example 115 includes the subject matter of any of Examples 111-114, and wherein the circuitry for sending the registration data comprises circuitry for sending registration data for one or more software resources of the server node.

Example 116 includes the subject matter of any of Examples 111-115, and wherein the circuitry for monitoring resource utilizations comprises circuitry for monitoring the utilization of one or more physical resources of the server node.

Example 117 includes the subject matter of any of Examples 111-116, and wherein the circuitry for monitoring resource utilizations comprises circuitry for monitoring the utilization of a central processing unit of the server node.

Example 118 includes the subject matter of any of Examples 111-117, and wherein the circuitry for monitoring resource utilizations comprises circuitry for monitoring the utilization of an accelerator of the server node.

Example 119 includes the subject matter of any of Examples 111-118, and wherein the circuitry for monitoring resource utilizations comprises circuitry for monitoring the utilization of a memory of the server node.

Example 120 includes the subject matter of any of Examples 111-119, and wherein the circuitry for monitoring resource utilizations comprises circuitry for monitoring the utilization of one or more data storage devices of the server node.

Example 121 includes the subject matter of any of Examples 111-120, and wherein the circuitry for monitoring resource utilizations comprises circuitry for monitoring the utilization of one or more software resources of the server node.

Example 122 includes the subject matter of any of Examples 111-121, and wherein the circuitry for monitoring the utilization of one or more software resources of the server node comprises circuitry for monitoring the utilization of a database of the server node.

Example 123 includes the subject matter of any of Examples 111-122, and wherein the circuitry for monitoring the utilization of a database of the server node comprises circuitry for determining a number of incomplete database requests.

Example 124 includes the subject matter of any of Examples 111-123, and wherein the circuitry for monitoring the utilization of a database of the server node comprises circuitry for determining an average amount of time to complete a database request.

Example 125 includes the subject matter of any of Examples 111-124, and wherein the circuitry for reporting the resource utilizations as telemetry data comprises circuitry for reporting the telemetry data in response to receipt of a request from a software stack of the server node to send a telemetry update to the network switch.

Example 126 includes the subject matter of any of Examples 111-125, and wherein the circuitry for reporting the telemetry data comprises circuitry for reporting the telemetry data through a virtual channel.

1. A network switch for managing the distribution of workloads among a set of server nodes, the network switch comprising:
one or more processors;
one or more memory devices having stored therein a plurality of instructions that, when executed, cause the network switch to:
receive a message;
route the message to a destination computer;
receive a request to perform a workload;
receive telemetry data from a plurality of server nodes in communication with the network switch, wherein the telemetry data is indicative of a present load on one or more resources of each server node;
determine channel utilization data for each of the server nodes, wherein the channel utilization data is indicative of a present amount of network bandwidth of the server node;
select, as a function of the telemetry data and the channel utilization data, one or more of the server nodes to execute the workload; and
assign the workload to the selected one or more server nodes.

2. The network switch of claim 1, wherein to select the one or more server nodes comprises to select the one or more server nodes further as a function of a target quality of service to be satisfied in the execution of the workload.

3. The network switch of claim 1, wherein to receive the request to perform the workload comprises to receive an indication of a resource sensitivity associated with the workload, wherein the resource sensitivity is indicative of one or more resources that the workload will primarily utilize when executed.

4. The network switch of claim 1, wherein to select the one or more server nodes comprises to utilize dedicated load balancer logic of the network switch to select the one or more server nodes.

5. The network switch of claim 4, wherein the dedicated load balancer logic comprises a field programmable gate array (FPGA) and the network switch is further to:
obtain a bit stream indicative of a configuration of the FPGA to perform a load balancing operation; and
provide the bit stream to the FPGA to configure the FPGA to perform the load balancing operation.

6. The network switch of claim 1, wherein, when executed, the plurality of instructions further cause the network switch to identify one or more inoperative server nodes, and
wherein to select one or more server nodes to perform the workload comprises to exclude the one or more inoperative server nodes from the selection.

7. The network switch of claim 1, wherein:
to receive the request comprises to receive a designation of one or more of the server nodes to perform the workload; and
to select the one or more server nodes comprises to select one or more server nodes designated in the request.

8. The network switch of claim 1, wherein, when executed, the plurality of instructions further cause the network switch to receive resource registration data from the server nodes, wherein the resource registration data is indicative of a unique identifier for each resource, a type of each resource, and capabilities of each resource.

9. The network switch of claim 8, wherein to receive the resource registration data comprise to receive resource registration data associated with one or more physical resources of the server nodes.

10. The network switch of claim 8, wherein to receive the resource registration data comprises to receive resource registration data associated with one or more software resources of the server nodes.

11. The network switch of claim 1, wherein to receive the telemetry data comprise to receive the telemetry data through a virtual channel with each of the server nodes.

12. The network switch of claim 1, wherein to receive the telemetry data comprises to receive load data indicative of a load on one or more physical resources of the one or more server nodes.

13. One or more machine-readable storage media comprising a plurality of instructions stored thereon that, in response to being executed, cause a network switch to:
receive a message;
route the message to a destination computer;
receive a request to perform a workload;
receive telemetry data from a plurality of server nodes in communication with the network switch, wherein the telemetry data is indicative of a present load on one or more resources of each server node;
determine channel utilization data for each of the server nodes, wherein the channel utilization data is indicative of a present amount of network bandwidth of the server node;
select, as a function of the telemetry data and the channel utilization data, one or more of the server nodes to execute the workload; and
assign the workload to the selected one or more server nodes.

14. The one or more machine-readable storage media of claim 13, wherein to select the one or more server nodes comprises to select the one or more server nodes further as a function of a target quality of service to be satisfied in the execution of the workload.

15. The one or more machine-readable storage media of claim 13, wherein to receive the request to perform the workload comprises to receive an indication of a resource sensitivity associated with the workload, wherein the resource sensitivity is indicative of one or more resources that the workload will primarily utilize when executed.

16. The one or more machine-readable storage media of claim 13, wherein to select the one or more server nodes comprises to utilize dedicated load balancer logic of the network switch to select the one or more server nodes.

17. The one or more machine-readable storage media of claim 16, wherein the dedicated load balancer logic comprises a field programmable gate array (FPGA) and the plurality of instructions, when executed, further cause the network switch to:
obtain a bit stream indicative of a configuration of the FPGA to perform a load balancing operation; and
provide the bit stream to the FPGA to configure the FPGA to perform the load balancing operation.

18. The one or more machine-readable storage media of claim 13, wherein, when executed, the plurality of instructions further cause the network switch to identify one or more inoperative server nodes, and
wherein to select one or more server nodes to perform the workload comprises to exclude the one or more inoperative server nodes from the selection.

19. The one or more machine-readable storage media of claim 13, wherein:
to receive the request comprises to receive a designation of one or more of the server nodes to perform the workload; and
to select the one or more server nodes comprises to select one or more server nodes designated in the request.

20. The one or more machine-readable storage media of claim 13, wherein, when executed, the plurality of instructions further cause the network switch to receive resource registration data from the server nodes, wherein the resource registration data is indicative of a unique identifier for each resource, a type of each resource, and capabilities of each resource.

21. The one or more machine-readable storage media of claim 20, wherein to receive the resource registration data comprise to receive resource registration data associated with one or more physical resources of the server nodes.

22. The one or more machine-readable storage media of claim 20, wherein to receive the resource registration data comprises to receive resource registration data associated with one or more software resources of the server nodes.

23. The one or more machine-readable storage media of claim 13, wherein to receive the telemetry data comprise to receive the telemetry data through a virtual channel with each of the server nodes.

24. The one or more machine-readable storage media of claim 13, wherein to receive the telemetry data comprises to receive load data indicative of a load on one or more physical resources of the one or more server nodes.

25. A network switch for managing the distribution of workloads among a set of server nodes, the network switch comprising:
circuitry for receiving a message;
circuitry for routing the message to a destination computer;
circuitry for receiving a request to perform a workload;
circuitry for receiving telemetry data from a plurality of server nodes in communication with the network switch, wherein the telemetry data is indicative of a present load on one or more resources of each server node;
circuitry for determining channel utilization data for each of the server nodes, wherein the channel utilization data is indicative of a present amount of network bandwidth of the server node;
means for selecting, as a function of the telemetry data and the channel utilization data, one or more of the server nodes to execute the workload; and
circuitry for assigning the workload to the selected one or more server nodes.

26. A method for managing the distribution of workloads among a set of server nodes, the method comprising:
receiving, by a network switch, a message;
routing, by the network switch, the message to a destination computer;
receiving, by the network switch, a request to perform a workload;
receiving, by the network switch, telemetry data from a plurality of server nodes in communication with the network switch, wherein the telemetry data is indicative of a present load on one or more resources of each server node;
determining, by the network switch, channel utilization data for each of the server nodes, wherein the channel utilization data is indicative of a present amount of network bandwidth of the server node;
selecting, by the network switch and as a function of the telemetry data and the channel utilization data, one or more of the server nodes to execute the workload; and
assigning, by the network switch, the workload to the selected one or more server nodes.

27. The method of claim 26, wherein selecting the one or more server nodes comprises selecting the one or more server nodes further as a function of a target quality of service to be satisfied in the execution of the workload.

28. The method of claim 26, wherein receiving the request to perform the workload comprises receiving an indication of a resource sensitivity associated with the workload, wherein the resource sensitivity is indicative of one or more resources that the workload will primarily utilize when executed.
